(19) United States
(12) Patent Application Publication
(10) Pub. No.: US 2024/0223392 A1
(43) Pub. Date: Jul. 4, 2024

(54) NETWORK UNIT, POWER SUPPLY DEVICE, MAINTENANCE SYSTEM, COMPUTER PROGRAM, AND POWER SUPPLY DEVICE DATA TRANSMISSION METHOD

(71) Applicant: GS Yuasa International Ltd., Kyoto-shi, Kyoto (JP)

(72) Inventor: Tomikatsu UCHIHORI, Kyoto-shi, Kyoto (JP)

(21) Appl. No.: 18/557,628

(22) PCT Filed: Mar. 17, 2022
(86) PCT No.: PCT/JP2022/012196

§ 371 Date: Oct. 27, 2023

(30) Foreign Application Priority Data
Apr. 30, 2021 (JP) 2021-077798

(51) Int. Cl. H04L 12/10; G06F 1/30

(52) U.S. Cl. CPC H04L 12/10; G06F 1/30

(57) ABSTRACT

A network unit includes: a first communication unit that receives data from a power supply device including a power converter; a second communication unit that performs communication via a specific network; a third communication unit that performs communication via a communication medium different from the specific network; an operating unit including a changeover switch; and a control unit that controls communication performed by the first communication unit to the third communication unit. The control unit communicates with another device by the second communication unit in accordance with setting in the specific network corresponding to a state of the changeover switch. When the network unit is activated with a state of the changeover switch being in a predetermined state, the control unit is communicably connected to a specific communication device by the third communication unit.

### CROSS REFERENCE TO RELATED APPLICATIONS

This application is a National Stage Application, filed under 35 U.S.C. § 371, of International Application No. PCT/JP2022/012196, filed Mar. 17, 2022, which international application claims priority to and the benefit of Japanese Application No. 2021-077798, filed Apr. 30, 2021; the contents of both of which as are hereby incorporated by reference in their entireties.

### BACKGROUND

### Technical Field

The present invention relates to the maintenance of a system that includes a power supply device, and more specifically, to a network unit, a power supply device, a maintenance system, a computer program, and a method of transmitting data relating to the power supply device all of which facilitate a maintenance operation.

### Description of Related Art

A periodic inspection is indispensable for a system that includes a power supply device. In performing the inspection, a maintenance worker acquires, from the power supply device included in the system, data such as an operation log of the device and the presence or the absence of abnormality in the device.

Patent document JP-A-2018-201331 discloses a technique where an information terminal is communicably connected to a network unit that a power supply device includes so as to allow a maintenance worker to easily acquire data relating to the power supply device. The network unit includes: a communication unit connected to a management network for transmitting data to a computer for management; and a wireless communication unit for a wireless communication line provided independently from the management network. The maintenance worker connects an information terminal that he/she brings to the network unit via the wireless communication unit. The information terminal can acquire data relating to the power supply device via the wireless communication line.

### BRIEF SUMMARY

The wireless communication connection between the network unit that is connected to the management network and the information terminal of the maintenance worker is required to be performed with a high degree of safety. In addition to the above-mentioned requirement, the restriction is imposed on the inspection of the system that includes the power supply device in terms of time constraints, and a customer has to attend the inspection. In view of such circumstances, there has been a demand for a method that can connect the network unit and the information terminal safely and smoothly.

As a typical power supply device, a power conditioning system, an inverter, a d.c. power supply, and an a.c. power supply are named. For example, the power conditioning system is required to control outputting of power corresponding to a power supply and demand. To satisfy such a requirement, the power conditioning system is communicably connected to a power server that a provider such as an electric power company manages, and acquires an output control schedule corresponding to a power supply and demand predicted by the electric power company. Timing at which the power conditioning system can acquire the output control schedule cannot be grasped from a power conditioning system side and hence, the power conditioning system is required to constantly maintain the communication connection with the power server. It is necessary to communicably connect the power supply device and an information terminal of a maintenance worker at the time of inspection without obstructing the communication connection between the power conditioning system and the power server.

It is an object of the present invention to provide a network unit, a power supply device, a maintenance system, a computer program, and a data transmission method relating to the power supply device.

A network unit includes: a first communication unit that receives data from a power supply device including a power converter; a second communication unit that performs communication via a specific network; a third communication unit that performs communication via a communication medium different from the specific network; an operating unit including a changeover switch; and a control unit that controls communication performed by the first communication unit to the third communication unit. The control unit communicates with another device by the second communication unit in accordance with setting in the specific network corresponding to a state of the changeover switch. When the network unit is activated with the state of the changeover switch being in a predetermined state, the control unit is communicably connected to a specific communication device by the third communication unit.

### BRIEF DESCRIPTION OF THE FIGURES

FIG. 1 is a view illustrating an overall configuration of a maintenance system.

FIG. 2 is a view illustrating an external appearance of a network unit.

FIG. 3 is a diagram illustrating the configuration of the network unit.

FIG. 4 is a block diagram illustrating the configuration of a maintenance terminal device.

FIG. 5 is formed of tables illustrating an example of a connection mode.

FIG. 6 is a flowchart illustrating an example of steps of processing performed by the network unit.

FIG. 7 is a flowchart illustrating an example of steps of communication processing performed in accordance with a fourth connection mode.

FIG. 8 is a view illustrating an overall configuration of a system where a plurality of power conditioning systems are connected to each other.

### DETAILED DESCRIPTION OF VARIOUS EMBODIMENTS

A network unit includes: a first communication unit that receives data from a power supply device including a power converter; a second communication unit that performs communication via a specific network; a third communication unit that performs communication via a communication medium different from the specific network; an operating unit including a changeover switch; and a control unit that controls communication performed by the first communication unit to the third communication unit. The control unit communicates with another device by the second communication unit in accordance with setting in the specific network corresponding to a state of the changeover switch. When the network unit is activated with the state of the changeover switch being in a predetermined state, the control unit is communicably connected to a specific communication device by the third communication unit.

Data received from the power supply device may include measurement data (for example, log data of a voltage, a current, and a temperature) of the power supply device. Data may include data on the state of the power supply device (for example, normal/abnormal, an operation mode). Data may include command values, information relating to a command values and a control. Data may include only a part of these data.

The changeover switch is preferably a mechanical switch that is minimally affected by an electromagnetic noise or the like. However, the changeover switch is not limited the mechanical switch. The changeover switch may be formed of a plurality of dip switches. With the use of the plurality of dip switches, a plurality of states other than the above-mentioned predetermined state can be set. That is, a plurality of various communication connections can be set including: the communication connection in a specific network that uses wired communication and/or wireless communication; and the communication connection with a specific communication device.

With the above-mentioned configuration, for example, a communication device (a maintenance terminal device) that a maintenance worker carries is communicably connected to a network unit via a third communication unit only when the maintenance worker activates the network unit by setting the changeover switch to a predetermined state. Even when the third communication unit used for communication with the specific communication device is disabled, the network unit is forcibly transcended to a state where the network unit can perform the communication connection with the maintenance terminal device.

The maintenance worker can take in data of the power supply device into the maintenance terminal device by simple processing of operating the changeover switch and of activating the network unit. It is unnecessary for the maintenance worker to connect the maintenance terminal device to a specific network (for example, a customer management network). Accordingly, the maintenance worker can perform the maintenance work safely and smoothly. The network unit can also maintain the communication with another device via a specific network by the second communication unit during a period in which the network unit performs the communication with the maintenance terminal device by the third communication unit.

The operating unit of the network unit may include a reset unit that generates an interruption in the control unit. Each time the reset unit is operated so that the interruption is generated, the control unit may determine whether or not the state of the changeover switch is the above-mentioned predetermined state.

The reset unit is preferably a mechanical switch that a maintenance operator can easily operate, or may be a reset button or a reset switch.

With the above-mentioned configuration, a maintenance worker can, by performing simple processing of bringing the changeover switch into a predetermined state and by operating the reset unit, take in data relating to the power supply device to which the network unit is connected or on which the network unit is mounted into the maintenance terminal device.

The control unit of the network unit may be provided independently from a power supply device control unit that controls the power converter, and the network unit may continue the operation of the power supply device during a period in which the network unit is activated with the state of the changeover switch being in the predetermined state.

The power supply device may be a power conditioning system, a grid-connected inverter used in a cogeneration system, a power conditioning system including energy storage devices, or a power conditioning system for an electric vehicle. The power supply device may be a d.c. power supply or an a.c. power supply (an uninterruptible power system). These various power supply devices are used as a social infrastructure. It is not preferable to stop the operation of the power supply device (stop inputting/outputting of power) for performing the inspection or the maintenance. For example, when the operation of the power conditioning system is stopped, there may occur a loss of opportunity such as a case where electricity generated by solar cells cannot be sold or consumed a case where an opportunity to respond to a demand response command is missed. When a power failure occurs in the midst of performing a bypass operation to an electric load to cope with a stoppage of a power converter of an uninterruptible power system, the supply of electricity to the load is interrupted and hence, the power supply device cannot perform its function originally required as a power supply device.

As described above, by providing the control unit of the network unit independently from the power supply device control unit that controls the power converter, the operation of the power supply device (the power inputting/outputting performed by the power converter) can be continued during a period that the network unit is activated.

The power converter that the power supply device includes may be a so-called converter that converts alternating current power into direct current power, or may be a so-called inverter that converts direct current power into alternating current power. The power converter may be a converter that converts direct current power into direct current power having a voltage different from a voltage of the former direct current power. The power supply device may include a plurality of power converters (for example, a converter and an inverter).

When a predetermined timeout period has elapsed after the network unit is activated with the state of the changeover switch being in the predetermined state, the control unit may transition to a state where the control unit performs the communication in accordance with the setting by the second communication unit.

With the above-mentioned configuration, even when the maintenance worker inadvertently forgets to return the changeover switch to the original state after performing an operation of fetching the data relating to the power supply device into the maintenance terminal device, such an inadvertent operation is permissible. Even when the changeover switch remains in the predetermined state, the network unit can restart the communication in accordance with the setting by the second communication unit.

When the network unit is activated with the state of the changeover switch being in the predetermined state, the control unit may cause the third communication unit to function as an access point, and may perform the communication connection with a communication device that transmits a valid password.

With the above-mentioned configuration, for example, provided that the maintenance terminal device safely stores a password valid for the network unit, the maintenance terminal device can perform an operation of fetching data of the power supply device into the maintenance terminal device by a simple operation without connecting the maintenance terminal device to the network of the customer.

The maintenance system includes: a network unit that receives data from a power supply device that includes a power converter by a first communication unit, and transmits the data to another device; and a maintenance terminal device that includes a communication unit that is communicably connected to the network unit. The network unit includes: a second communication unit that performs communication via a specific network; a third communication unit that performs communication via a communication medium that differs from the above-mentioned specific network; an operating unit that includes a changeover switch; and a control unit that controls communication from the first communication unit to the third communication unit. The control unit transmits the data from the second communication unit or the third communication unit in accordance with the setting in the specific network in response to the state of the changeover switch. When the network unit is activated with a state of the changeover switch being in a predetermined state, the control unit is communicably connected to the maintenance terminal device by the third communication unit, and transmits the above-mentioned data to the maintenance terminal device.

The computer program is executed by a computer that includes a communication unit that performs communication via a wired communication line and/or a wireless communication medium; and an operating unit that includes a changeover switch. A computer program causes a computer to execute processing including: transmitting the data from the communication unit in accordance with setting in a specific network in response to the state of the changeover switch while receiving data from a power supply device that includes a power converter; establishing communication connection with a specific communication device via a communication medium that differs from the specific network when the computer is activated with the state of the changeover switch being in a predetermined state; and transmitting the data to the specific communication device.

A power supply device data transmission method is a method in which a network unit that includes a communication unit that performs communication via a wired communication line and/or a wireless communication medium and an operating unit that includes a changeover switch receives data from a power supply device that includes a power converter and transmits the data to another device. A power supply device data transmission method includes processing in which the network unit transmits the data from the communication unit to a specific network in accordance with a setting in the specific network in response to a state of the changeover switch, and communicably connects with a specific communication device via a communication medium different from the specific network, and transmits the data to the specific communication device when the network unit is activated with the state of the changeover switch being in a predetermined state.

The present invention will be specifically described with reference to the drawings that illustrate embodiments of the present invention.

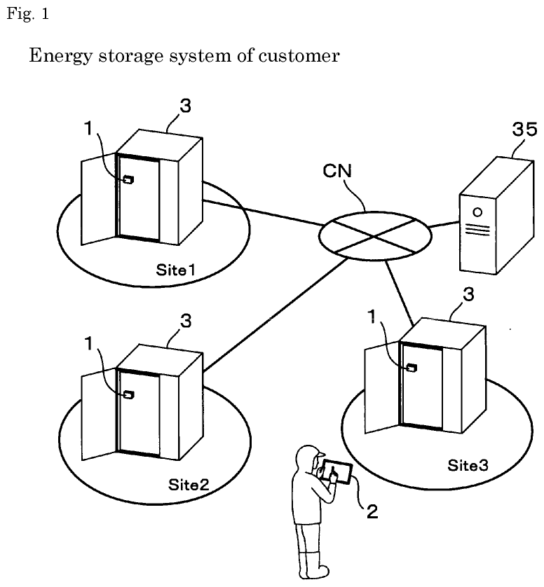

FIG. 1 is a view illustrating an overall configuration of a maintenance system. A maintenance worker performs a maintenance operation using a network unit 1 and a maintenance terminal device 2 (an example of a communication device). The network unit 1 is provided in a power supply device 3 to be maintained.

The power supply device 3 that is an object be maintained is, for example, a power conditioning system (PCS) having an output control function that is used for a solar power generating system. The power supply device 3 may be formed by connecting a plurality of power conditioning systems to each other. The power supply device 3 may be a grid interconnection inverter used in a cogeneration system. The power supply device 3 may be a power conditioning system that includes energy storage devices or a power conditioning system for an electric vehicle. In the example illustrated in FIG. 1, the power supply device 3 is installed at a plurality of sites (sites 1 to 3).

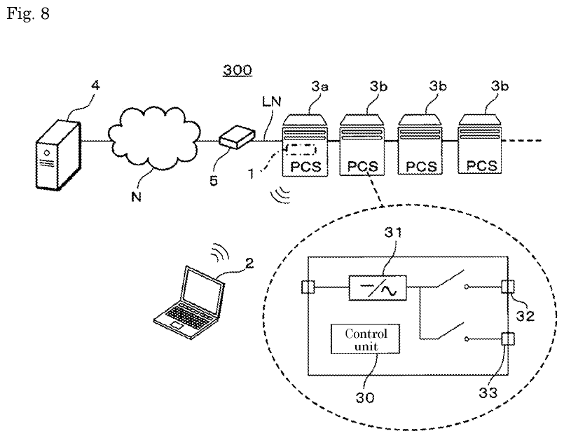

As another example, FIG. 8 illustrates a system 300 where a plurality of power conditioning systems are connected to each other. The network unit 1 is mounted on the power conditioning system 3a that functions as a master unit. The network unit 1 may be disposed in a housing of the power conditioning system 3a, or may be disposed in a box (for example, an output control unit) that is externally attached to the power conditioning system 3a. A power conditioning system 3b that functions as a slave unit is connected to the power conditioning system 3a so as to be able to communicate with a master unit via a communication cable. The system 300 includes a router 5 that connects a local area network LN and an external network (a wide area network) to each other. The power conditioning system 3a can communicate with a power server 4 via a public communication network N by the network unit 1. The power conditioning system 3a may be communicably connected to a remote monitoring server (an example of another device) (not illustrated in the drawing). As described later, the network unit 1 of the power conditioning system 3a can perform communication with the maintenance terminal device 2 that a maintenance worker carries with him/her without via the router 5.

As illustrated in FIG. 8, each of power conditioning systems 3a, 3b includes a control unit 30 (an example of a power supply device control unit) and an inverter 31 (an example of a power converter). Each of power conditioning systems 3a, 3b may include an interconnection output terminal 32 and a self-sustained operating output terminal 33.

Even when the communication with the network unit 1 (for example, the reception of a command signal from the network unit 1) is interrupted, the control unit 30 continues its operation for a predetermined period (for example, several minutes, or a period longer than time required for reactivating the network unit 1) without outputting an abnormality alarm or stopping its operation. Accordingly, as described later, the control unit 30 can continue inputting and outputting of power by operating the inverter 31 during a period until the network unit 1 is reactivated (for example, several 10 seconds).

In the system illustrated in FIG. 1, data on an operation log of the device obtained from the power supply device 3, the presence or absence of abnormality in the device, a power generating system that is connected to the device and the like are collected in a management device 35 that a customer manages, and the state of the power supply device 3 is grasped. Each power supply device 3 includes the network unit 1. The power supply device 3 is connected to a customer network CN (a local area network) that a customer (a user) manages via the network unit 1. The customer network CN may be either a wired communication line or a wireless communication line. The power supply device 3 can transmit and receive data to and from the management device 35 (an example of another device) in the customer network CN via the network unit 1. For example, the power supply device 3 transmits data relating to the power supply device to the management device 35.

Each power supply device 3 is communicably connected to a power server or a remote monitoring server via a router for an external network (not illustrated in the drawing) by the network unit 1. Each network unit 1 can perform communication with the maintenance terminal device 2 that a maintenance worker carries without a router.

The maintenance worker communicably connects the maintenance terminal device 2 to the network unit 1 to each other in a customer management area. As described above, the network units 1 are connected to the customer network CN. When the network unit 1 is disconnected from the customer network CN in order to connect the network unit 1 to the maintenance terminal device 2, the power supply device 3 cannot transmit data to the management device 35 or cannot perform communication with the power server. The network unit 1 according to the present embodiment includes a wireless communication unit for connecting the network unit 1 to the maintenance terminal device 2 through a wireless communication line that is provided independently from the customer network CN. With such a configuration, the maintenance terminal device 2 can perform communication with the network unit 1 without separating the network unit 1 from the customer network CN (without obstructing the transmission and the reception of data to and from the management device 35 or the power server).

It is necessary that the connection between the maintenance terminal device 2 and the wireless communication unit of the network unit 1 is enabled only when the maintenance worker goes to a customer management area. If the wireless communication unit is unnecessarily enabled, a risk of improper connection to the power supply device 3 via the wireless communication unit is increased. It is preferable that the wireless communication unit that is not used be disabled.

To enable the unused wireless communication unit, a maintenance worker may connect the maintenance terminal device 2 to the customer network CN and may transmit a command to the network unit 1 via the customer network CN. However, the network unit 1 and the power supply device 3 are managed by a customer who has purchased or has rented the power supply device 3. Accordingly, from the viewpoint of security, it should be avoided to connect the maintenance terminal device 2 of the maintenance worker to the customer network CN.

In a case where the customer network CN is a wireless communication line, the power supply device 3 can be connected to the management device 35 via a wireless communication unit of the network unit 1. The power supply device 3 can transmit and receive data to and from the power server via the wireless communication unit and the router. When the communication management device (a router, a DHCP server) of the customer allocates an IP address of the network unit 1 in the customer network CN to the wireless communication unit, the management device 35 can be connected to the network unit 1 via the wireless communication unit. To connect the maintenance terminal device 2 to the network unit 1, the maintenance terminal device 2 may be connected to the customer network CN. However, it should be avoided to connect the maintenance terminal device 2 to the customer network CN.

The maintenance terminal device 2 and the wireless communication unit of the network unit 1 are connected to each other by a wireless communication line provided independently from the customer network CN only at the time of performing a maintenance work. Accordingly, the wireless communication unit in the present embodiment temporarily functions as an access point. Hereinafter, the configuration and the processing for temporarily enabling the wireless communication unit will be described.

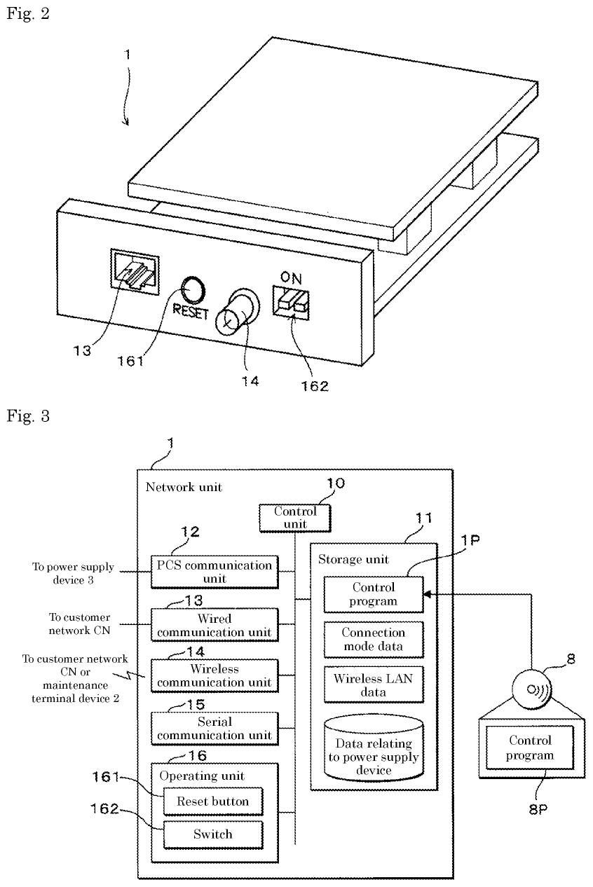

FIG. 2 illustrates an external appearance of the network unit 1, and FIG. 3 illustrates the configuration of the network unit 1. The network unit 1 is a communication device of a network card type. The network unit 1 includes a control unit 10, a storage unit 11, a PCS communication unit 12, a wired communication unit 13, a wireless communication unit 14, a serial communication unit 15, and an operating unit 16.

The control unit 10 is a microprocessor that includes a central processing unit (CPU). The control unit 10 performs the processing by controlling the respective constitutional units using a built-in memory such as a read only memory (ROM) and a random access memory (RAM). The ROM of the memory stores a predetermined control program 1P, connection mode data, and wireless LAN data (network setting data). The control program 1P includes a program for communication processing described later, a program of processing for acquiring data of the power supply device 3, and a web server program. The control program 1P may be a program that is obtained by allowing the control unit 10 to read out a control program 8P stored in a recording medium 8 and by copying the control program 8P to the ROM. The network setting data includes data in an address band that is used as an access point. The data in the address band may include data of a plurality of patterns, for example, main data and sub data in consideration of a case where the data in the address band overlaps with data in an address band used in the customer network CN.

The storage unit 11 is formed of a nonvolatile memory such as a flash memory. The storage unit 11 stores data relating to the devices that the storage unit 11 has received from the power supply device 3.

The PCS communication unit 12 is a communication interface that realizes the communication between the network unit 1 and a control unit of the power supply device 3 to which the network unit 1 is connected. The PCS communication unit 12 is a communication interface such as an RS-232C or an RS-485.

The wired communication unit 13 is a communication device that realizes communication connection in a case where the customer network CN is a wired network. The wired communication unit 13 functions as a second communication unit when the customer network CN is a wired network. The wired communication unit 13 includes a connection interface compatible to the standard of the customer network CN. The customer network CN is, for example, Ethernet (registered trademark). The customer network CN may be an optical line. The customer network CN may be a network compatible to ECHONET/ECHONET Lite (registered trademark). The network unit 1 transmits data relating to an operation of the device acquired from the power supply device 3 via the PCS communication unit 12 to the management device 35 by the wired communication unit 13.

The wireless communication unit 14 is a wireless communication device for communication based on a wireless LAN. As illustrated in FIG. 2, the wireless communication unit 14 includes an antenna attachment interface, and an antenna may be an externally attached antenna. The wireless communication unit 14 may be a wireless communication device compatible with Bluetooth (registered trademark). In a case where the customer network CN is a wireless network, the wireless communication unit 14 functions as a second communication unit, and the control unit 10 may transmit data relating to an operation of the power supply device 3 to the management device 35 by the wireless communication unit 14.

In the inspection performed by a maintenance worker, the wireless communication unit 14 is used as a third communication unit that is communicably connected with the maintenance terminal device 2 via a communication medium that differs from the customer network CN. To enable the connection between the network unit 1 and the maintenance terminal device 2 in a different address band, the wireless communication unit 14 may enable the connection by selecting any one of the network setting data. In a case where the maintenance terminal device 2 is connected to the network unit 1 using the wireless communication unit 14, a maintenance worker may attach an external antenna only at the time of performing such a connecting operation.

The PCS communication unit 12, the wired communication unit 13, and the wireless communication unit 14 that are connected to the control unit (the communication unit) of the power supply device 3 are respectively formed of a hardware different from each other. However, the functions of these three communication units may be implemented by the same hardware provided that individual communication connections can be realized in accordance with communication protocols with the respective connection destinations. For example, in a case where the customer network CN is a wireless network, the wireless communication unit 14 may have both the function of the second communication unit and the function of the third communication unit. In this case, the network unit 1 may not include the wired communication unit 13.

The serial communication unit 15 is an external serial communication device. The serial communication unit 15 includes a connection interface for serial communication. The serial communication unit 15 is, for example, a universal serial bus (USB) interface. The network unit 1 acquires setting data from the maintenance terminal device 2 or another device by the serial communication unit 15. The provision of the serial communication unit 15 is not indispensable. In a case where the network unit 1 is externally attached to power supply device 3 (for example, the power conditioning system 3a), serial communication unit 15 may be used for connecting the control unit 10 to a control unit of the power supply device 3.

The operating unit 16 includes a reset button 161 and a switch 162. The reset button 161 makes the control unit 10 generate a reset interruption. When the reset button 161 is pressed, the control unit 10 detects this operation and is reactivated, and starts processing based on a control program 1P stored in the memory.

The switch 162 is a changeover switch. The switch 162 may be formed of one dip switch or may be formed of a plurality of dip switches. As shown in FIG. 2, the network unit 1 includes, for example, two dip switches. The control unit 10 acquires four switch states at maximum by two dip switches. The number of dip switches is not limited to two, and may be only one or three or more. The correspondence between the switch state and the connection mode data is stored in the memory. The control unit 10 acquires the switch state when the switch is activated, and controls respective components in accordance with the connection mode data corresponding to the acquired switch state. The switch 162 is not limited to a dip switch, and other switches may be used as the switch 162.

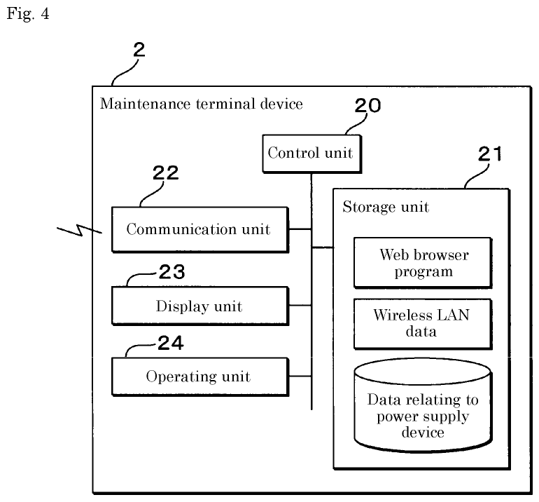

FIG. 4 is a block diagram illustrating the configuration of the maintenance terminal device 2. The maintenance terminal device 2 may be a desktop type computer or a laptop type personal computer. The maintenance terminal device 2 may be a so-called smartphone or a tablet type communication terminal. The maintenance terminal device 2 includes a control unit 20, a storage unit 21, a communication unit 22, a display unit 23, and an operating unit 24.

The control unit 20 is a processor that uses a CPU or a graphics processing unit (GPU). The control unit 20 can access data provided by the network unit 1 that functions as a web server based on a web browser program stored in the storage unit 21.

As the storage unit 21, for example, a nonvolatile memory such as a hard disk, a flash memory, or a solid state drive (SSD) is used. The storage unit 21 stores data that the control unit 20 looks up. The storage unit 21 stores various programs including a web browser program. The storage unit 21 stores data relating to the power supply device 3 acquired from the network unit 1. The storage unit 21 stores wireless LAN data for communication connection with the network unit 1. The wireless LAN data includes an SSID and a password of an access point. The wireless LAN data may store main data and sub data, and these data may be selectably used.

The communication unit 22 is a communication device for realizing data communication via a public communication network or a carrier network. The communication unit 22 includes a wireless LAN compatible communication device corresponding to the wireless communication unit 14 of the network unit 1. When the network unit 1 functions as an access point, the control unit 20 can be communicably connected to the network unit 1 by the communication unit 22. Conversely, the communication unit 22 may function as an access point, and may accept a communication connection from the network unit 1. The communication unit 22 may include: a network card for wired communication; and a wireless communication device compatible with a carrier network for mobile communication.

The display unit 23 may be a display such as a liquid crystal display or an organic electro luminescence (EL) display, or may be a display equipped with a built-in touch panel. The display unit 23 displays an image of a web page provided from the network unit 1.

The operating unit 24 is a user interface such as a keyboard or a pointing device capable of performing inputting and outputting of data and commands between the operating unit 24 and the control unit 20. The operating unit 24 may be a voice inputting unit. The operating unit 24 may be a touch panel of the display unit 23. The operating unit 24 may be a physical button. The operating unit 24 notifies the control unit 20 of operation data inputted by a maintenance worker.

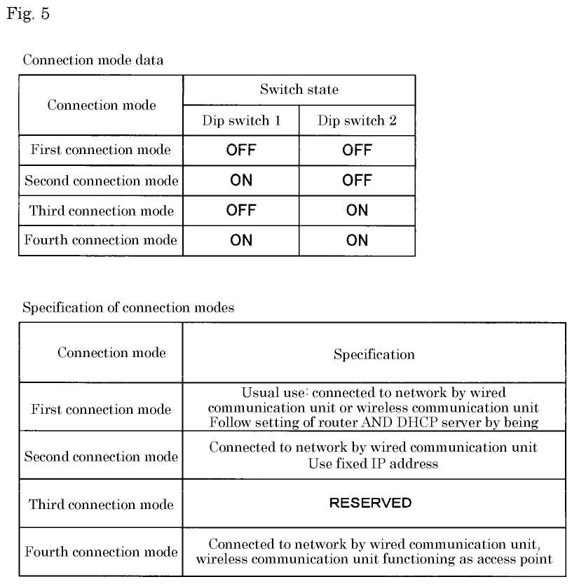

The connection mode set in the wireless communication unit 14 will be described. FIG. 5 illustrates an example of the connection mode. The connection mode is prepared corresponding to the configuration and the state of the switch 162. The memory of the control unit 10 stores the correspondence between the connection modes and the state of the switch 162 illustrated in FIG. 5 as connection mode data.

The first connection mode is a mode for communication via the customer network CN. The first connection mode is normally used during an operation of the power supply device 3. In the case of the first connection mode, the wired communication unit 13 and the wireless communication unit 14 are connected to the customer network CN based on the setting performed by the customer. In the case where the customer network CN is a wired network, the network unit 1 is connected to the customer network CN by the wired communication unit 13. In the case where the customer network CN is a wireless communication line, the network unit 1 is connected to the customer network CN by the wireless communication unit 14. In the first connection mode, the wired communication unit 13 or the wireless communication unit 14 is connected to another communication device in accordance with an address allocated to a router and a DHCP server of the customer network CN. In the first connection mode, the wireless communication unit 14 may be disabled.

The second connection mode is a mode for communication via the customer network CN. The second connection mode is used in a specific case. In the case of the second connection mode, the network unit 1 is connected to the customer network CN which is a wired line with a preset fixed IP address by the wired communication unit 13. In the case of the second connection mode, the network unit 1 may be connected to another wireless communication line managed by a customer based on setting performed by the customer by the wireless communication unit 14. In the second connection mode, the wireless communication unit 14 may be disabled.

The third connection mode is a mode that is used by a manufacturer or a distributor of the network unit 1 or the power supply device 3.

The fourth connection mode is a mode where the network unit 1 is communicably connected with the maintenance terminal device 2. In the fourth connection mode, while the network unit 1 is connected to the customer network CN by the wired communication unit 13, the wireless communication unit 14 functions as an access point to the maintenance terminal device 2. The wireless communication unit 14 outputs a radio wave that includes an SSID stored in advance, and establishes the communication connection with a communication device that knows a password corresponding to the SSID. In the fourth connection mode, the network unit 1 continues the transmission of data relating to the power supply device 3 to the management device 35 by the wired communication unit 13. Conversely, the mode may be set such that the communication unit 22 of the maintenance terminal device 2 functions as an access point, and the network unit 1 may function as a client.

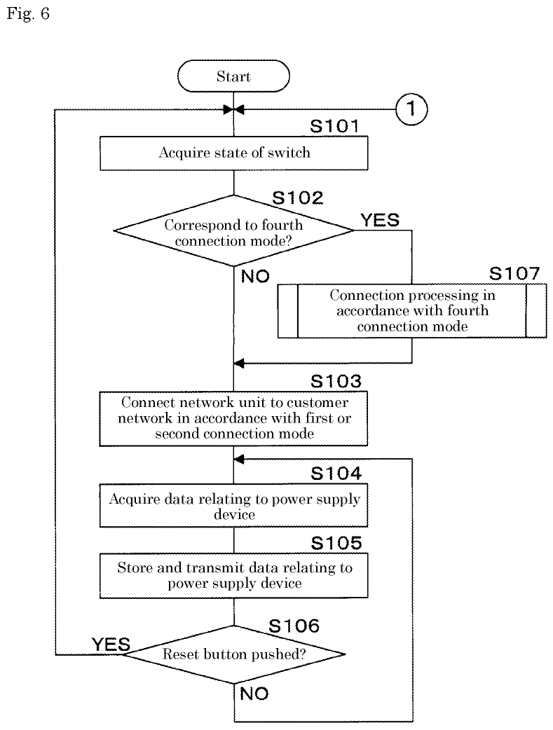

FIG. 6 is a flowchart illustrating an example of steps of processing performed by the network unit 1. When the control unit 10 receives power supply from a power supply unit (not illustrated in the drawing), the control unit 10 performs processing based on the control program 1P. The control unit 10 continues the following processing until the supply of electricity is stopped.

The control unit 10 acquires the state of the switch 162 (step S101). The control unit 10 determines whether or not the state of the switch corresponds to the fourth connection mode (step S102).

When the state of the switch does not correspond to the fourth connection mode (S102: NO), the control unit 10 establishes a communication connection between the network unit 1 and the customer network CN in accordance with the first connection mode or in accordance with the second connection mode (step S103).

The control unit 10 acquires data on the power supply device 3 from the PCS communication unit 12 (step S104). The control unit 10 stores the acquired data in the storage unit 11, and transmits the acquired data from the valid wired communication unit 13 or the valid wireless communication unit 14 to the management device 35 (step S105).

The control unit 10 determines whether or not the reset button 161 has been pressed (step S106). When the reset button 161 has not been pressed (S106: NO), the control unit 10 returns the processing to step S104. The control unit 10 continues the acquisition and the transmission of data relating to the power supply device 3.

When the reset button 161 is pressed (S106: YES), the control unit 10 returns the processing to step S101.

When the state of the switch corresponds to the fourth connection mode (S102: YES), the control unit 10 attempts the communication processing in accordance with the fourth connection mode (step S107). When the control unit 10 performs the communication processing in accordance with the fourth connection mode, the control unit 10 returns the processing to step S103.

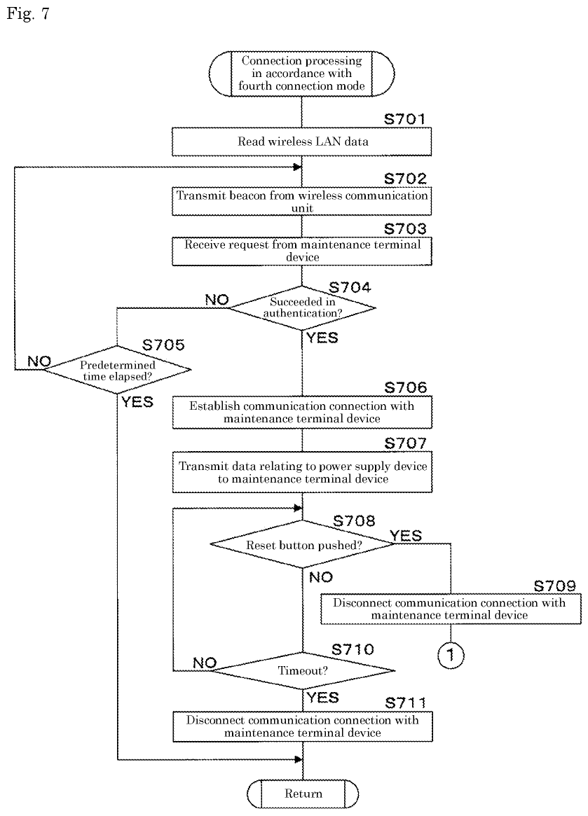

FIG. 7 is a flowchart illustrating an example of steps of the communication processing in accordance with the fourth connection mode. FIG. 7 corresponds to details of the communication processing in step S107 illustrated in FIG. 6.

The control unit 10 reads the wireless LAN data (an SSID and a password corresponding to the SSID) stored in advance in the memory (step S701).

The control unit 10 transmits a beacon from the wireless communication unit 14 and the wireless antenna (step S702). The control unit 10 receives a request including an SSID that agrees with the SSID read in step S701 from the maintenance terminal device 2 (step S703). In a case where the request cannot be received, the control unit 10 may advance the processing to step S705.

The control unit 10 determines whether or not the authentication based on the password read in step S701 succeeds with respect to the maintenance terminal device 2 which is a transmission source of the request (step S704).

When the authentication fails (S704: NO), the control unit 10 determines whether or not a predetermined time has elapsed (step S705). When the control unit 10 determines that the predetermined time has not elapsed (S705: NO), the control unit 10 returns the processing to step S702.

When the control unit 10 determines that the predetermined time has elapsed (S705: YES), the control unit 10 returns the processing to step S103 in FIG. 6. In this case, the control unit 10 stops the communication in accordance with the fourth connection mode, and connects the wired communication unit 13 or the wireless communication unit 14 to the customer network CN in accordance with the first connection mode.

When the authentication succeeds within the predetermined period (S704: YES), the control unit 10 establishes the communication connection with the maintenance terminal device 2 that is the transmission source of the request (step S706). The control unit 10 transmits the data relating to the power supply device 3 that is stored in the storage unit 11 to the maintenance terminal device 2 that is communicably connected with the network unit 1 (step S707). The control unit 10 may receive an access from the maintenance terminal device 2 as a web server, and may transmit web page data.

The control unit 10 determines whether or not the reset button 161 has been pressed (step S708). When the reset button 161 has been pressed (S708: YES), the control unit 10 disconnects the communication connection by the wireless communication unit 14 (step S709), returns the processing to step S101 in FIG. 6, and starts the processing similar to the processing at the time of activating the operation. When the state of the switch 162 has been changed before the reset button 161 is pressed, the control unit 10 performs processing corresponding to the state of the switch 162 after being changed.

When the reset button 161 has not been pressed (S708: NO), the control unit 10 determines whether or not the time from the activation in accordance with the fourth connection mode has passed a predetermined timeout period (step S710). The timeout period is a period of time such as one hour that is a time obtained by adding a surplus time to a time required for a maintenance operation. The memory of the control unit 10 stores the timeout period.

When the elapsed time from the activating of the network unit 1 in accordance with the fourth connection mode has not exceeded the predetermined timeout period (S710: NO), the control unit 10 returns the processing to step S708. The control unit 10 maintains the communication connection with the maintenance terminal device 2 until the reset button 161 is pressed or the timeout period elapses. During this period, the control unit 10 may continue the transmission of data relating to the device in response to a request from the maintenance terminal device 2. The control unit 10 may receive an instruction to the network unit 1 from the maintenance terminal device 2 by a web server function that the network unit 1 possesses.

When the elapsed time from the activating of the network unit 1 in the fourth connection mode has exceeded the predetermined timeout period (S710: YES), the control unit 10 disconnects the communication connection by the wireless communication unit 14 (step S711). The control unit 10 returns the processing to step S103 in FIG. 6. The control unit 10 connects the network unit 1 to the customer network CN in accordance with the first connection mode. Even if the maintenance worker forgets to return the state of the switch 162 to the state before performing the maintenance operation, the network unit 1 is connected to the customer network CN in accordance with the first connection mode.

When the maintenance worker goes to a management area of a customer who uses the power supply device 3 for maintenance and inspection, the maintenance worker performs the operation in accordance with the following steps. The maintenance worker goes to an operation site while carrying the maintenance terminal device 2 in which an SSID and a password corresponding to the network unit 1 are stored in advance. With the permission from the customer, the maintenance worker makes the state of the switch 162 of the network unit 1 in the power supply device 3 that is an object to be inspected correspond to the fourth connection mode with the attendance of the customer in the operation site. Specifically, the maintenance worker turns on all the dip switches of the switch 162. The maintenance worker presses the reset button 161 of the network unit 1 in a state where the switch 162 is set to be compatible with the fourth connection mode. As a result, the network unit 1 can perform the communication connection via the customer network CN, and can also perform the communication connection through a communication line independent from the customer network CN. If the customer permits, an operation is performed without customer's attendance on the operation site.

The maintenance worker operates the display unit 23 and the operating unit 24 of the maintenance terminal device 2 so as to attempt the communication connection with the network unit 1 that functions as an access point. The maintenance terminal device 2 can output candidates for the connectable network unit 1 on the display unit 23 based on an SSID included in a beacon from the network unit 1. When any one of the candidates is selected by the operating unit 24, the maintenance terminal device 2 transmits a request to the selected network unit 1. Accordingly, the communication connection is established between the target network unit 1 and the maintenance terminal device 2 carried by the maintenance worker.

If an address band set as an access point in the network unit 1 overlaps with an address band used in the customer network CN, the network unit 1 attempts the wireless communication using sub-data (automatically switched to a different segment IP having a different sub data). In a case where the maintenance terminal device 2 cannot establish the communication with the wireless communication unit 14 for main data, the maintenance terminal device 2 may select the communication with the wireless communication unit 14 for sub data in response to an operation from the maintenance worker on the operating unit 24. That is, the maintenance worker switches the operation mode to the communication with the wireless communication unit 14 for sub data by operating the operating unit 24.

When the communication connection is established, the maintenance terminal device 2 automatically acquires data relating to the power supply device 3 via the network unit 1, and stores the data in the storage unit 21. The control unit 20 of the maintenance terminal device 2 may store the data in the storage unit 21 together with identification data of the power supply device 3 or identification data of the network unit 1.

When the maintenance terminal device 2 completes the acquisition of the data on the power supply device 3, the maintenance worker returns the switch 162 to the state corresponding to the first connection mode or the second connection mode, and presses the reset button 161. The network unit 1 is connected to the customer network CN in the first connection mode or in the second connection mode and hence, the network unit 1 returns to a normal mode where the network unit 1 continues the acquisition and the transmission of data relating to the power supply device 3.

As described above, the network unit 1 realizes the communication connection with the specific maintenance terminal device 2 while maintaining connection with the customer network CN. The maintenance terminal device 2 can be easily connected to the network unit 1, while the maintenance terminal device 2 is not connected to the customer network CN. As a result, the maintenance worker can perform the operation smoothly, and can perform the operation safely with respect to the customer network CN. Further, the power supply device 3 can constantly maintain the state where the power supply device 3 is communicably connected with the power server and hence, the acquisition of an output control schedule is not obstructed by the maintenance.

In the above-mentioned example, the description is made with respect to the case where the network unit 1 is communicably connected to the maintenance terminal device 2 via the wireless communication unit 14. In the fourth connection mode, the network unit 1 may perform the P2P communication with the maintenance terminal device 2 by the wired communication unit 13 using the set IP address while transmitting data relating to the device from the wireless communication unit 14 to the management device 35.

The embodiments disclosed above are illustrative in all respects and are not limitative. The scope of the present invention is defined by the claims, and includes all modifications equivalent to the present invention in the meaning and within the scope of the claims.

1. A network unit comprising:
a first communication unit configured to receive data from a power supply device including a power converter;
a second communication unit configured to perform communication via a specific network;
a third communication unit configured to perform communication via a communication medium that differs from the specific network;
an operating unit that includes a changeover switch; and
a control unit configured to control the communications performed by the first communication unit to the third communication unit,
wherein
the control unit is configured to communicate with another device by the second communication unit in accordance with setting in the specific network in response to a state of the changeover switch, and
the control unit is configured to communicably connected to a specific communication device by the third communication unit when the network unit is activated with a state of the changeover switch being in a predetermined state.

2. The network unit according to claim 1, wherein
the operating unit includes a reset unit configured to generate an interruption in the control unit, and
the control unit is configured to determine whether or not the state of the changeover switch is the predetermined state each time the reset unit is operated so that the interruption is generated.

3. The network unit according to claim 1, wherein
the control unit is provided independently from a power supply device control unit that controls the power converter, and
the network unit is configured to continue an operation of the power supply device during a period in which the network unit is activated with the state of the changeover switch being in the predetermined state.

4. The network unit according to claim 1, wherein when a predetermined timeout period has elapsed after the network unit is activated with the state of the changeover switch being in the predetermined state, the control unit is configured to transition to a state where the control unit performs communication in accordance with the setting by the second communication unit.

5. The network unit according to claim 1, wherein when the network unit is activated with the state of the changeover switch being in the predetermined state, the control unit is configured to cause the third communication unit to function as an access point, and is configured to perform communication connection with a communication device that transmits a valid password.

6. A power supply device comprising:
a power converter; and
the network unit according to claim 1.

7. A maintenance system comprising:
a network unit configured to receive data from a power supply device including a power converter by a first communication unit and transmit the data to the other; and
a maintenance terminal device including a communication unit that is communicably connected to the network unit,
wherein
the network unit includes:
a second communication unit configured to perform communication via a specific network;
a third communication unit configured to perform communication via a communication medium that differs from the specific network;
an operating unit that includes a changeover switch; and
a control unit configured to control the communications performed by the first communication unit to the third communication unit,
the control unit is configured to communicate with another device by the second communication unit or the third communication unit in accordance with setting in the specific network in response to a state of the changeover switch, and
the control unit is configured to communicably connected to the maintenance terminal device by the third communication unit so as to transmit the data to the maintenance terminal device when the network unit is activated with the state of the changeover switch being in a predetermined state.

8. A computer program allowing a computer that includes a communication unit configured to perform communication via a wired communication line and/or a wireless communication medium, and an operating unit that includes a changeover switch to execute processing that includes:
receiving of data from a power supply device including a power converter;
communication with another device by the communication unit in accordance with setting in a specific network in response to a state of the changeover switch;
communication connection with a specific communication device via a communication medium that differs from the specific network when the computer is activated with the state of the changeover switch being in a predetermined state; and
transmission of the data to the specific communication device.

9. A power supply device data transmission method in which a network unit that includes: a communication unit that performs communication via a wired communication line and/or a wireless communication medium; and an operating unit that includes a changeover switch, receives data from a power supply device that includes a power converter and transmits the data to another device, the power supply device data transmission method comprising processing in which
the network unit
communicates with another device by the communication unit in accordance with setting in a specific network in response to a state of the changeover switch,
communicably connects with a specific communication device via a communication medium that differs from the specific network when the network unit is activated with the state of the changeover switch being in a predetermined state, and
transmits the data to the specific communication device.
